(19) United States
(12) Patent Application Publication
(10) Pub. No.: US 2003/0126284 A1
(43) Pub. Date: Jul. 3, 2003

(54) Relating to auto-tunnelling in a heterogeneous network

(76) Inventors: Allen Houston, Ballyclare (GB); Terence Canning, Belfast (GB); Nuala Sheerin, Belfast (GB)

Correspondence Address: William M. Lee, Jr., LEE, MANN, SMITH, MCWILLIAMS, SWEENEY & OHLSON, P.O. Box 2786, Chicago, IL, 60690, US

(21) Appl. No.: 10/039,432

(22) Filed: Jan. 3, 2002

(51) Int. Cl. G06F 15/173

(52) U.S. Cl. 709/238

(57) ABSTRACT

In the preferred embodiment, the invention provides a modified Shortest Path First routing algorithm for use in a heterogeneous network. The muting algorithm is modified to identify bi-lingual network nodes as it calculates shortest paths. Once a node has been identified as bi-lingual, this information is carried over into subsequent path entries created by the routing algorithm. This arrangement reduces the computational burden on the routing algorithm when identifying bi-lingual routers. The algorithm may be modified to enable the use of an encapsulation capability identifier to indicate the encapsulation capability of bi-lingual routers, and the algorithm may be modified to use the encapsulation capability identifier in the calculation of the shortest paths.

### FIELD OF THE INVENTION

The present invention relates to auto-tunnelling in a heterogeneous network. The invention relates particularly to the identification of dual protocol, or bi-lingual, network elements in a heterogeneous network.

### BACKGROUND TO THE INVENTION

In a heterogeneous network, each network element, or node, may support one or more protocol sets. For example, a network element may support OSI (Open System Interconnect) protocols and/or IP (Internet protocols) protocols. In order that one network element may communicate with another network element, they must support at least one protocol set in common since different protocol sets do not interoperate. It is possible to send data packets, or traffic, conforming with one protocol set to a destination via one or more network elements that do not support the protocol set of the data by means of data tunnelling. Data tunnelling involves the encapsulation of one protocol set within another protocol set. For example, assume that it is desired to send IP data packets from a source network element that supports IP protocols to a destination network element that also supports IP protocols via a subnetwork comprising network elements that only support OSI protocols. The IP data packets are encapsulated within OSI protocols for their passage through the OSI-only network elements and de-encapsulated afterwards. In order that data tunnelling may be achieved, at least some of the network elements between the source and the destination must be able to support both protocol sets. Such network elements are said to be bi-lingual.

A scheme for auto-tunnelling in a heterogeneous network has previously been proposed in which bi-lingual network elements are arranged to create automatically and dynamically data tunnels in order to forward traffic across a heterogeneous network. To do this, the bi-lingual network elements need to know the identity of at least one network element in the path to the destination that is bi-lingual. In particular, a bi-lingual network element is required to know the nearest other network element that supports at least two protocol sets in common with itself. The referred to auto-tunnelling scheme is described in International PCT patent application number PCT/EP01/14203, which is hereby incorporated herein by way of reference.

In order to learn about the network around it, and to calculate paths across the network to destination nodes, a network element usually runs a routing algorithm. Typically, the calculation of the routing algorithm is a computationally intensive operation and accounts for a significant proportion of the network element's processing time. The compilation of information concerning nearest bi-lingual network elements, as required by the aforementioned auto-tunnelling scheme, must be performed in addition to the normal tasks of the routing algorithm. It is therefore desirable to compile said information in an efficient manner in order to reduce the computational burden and so improve the speed of operation of the network element.

It will be understood that the term “protocol” as used herein is intended to embrace protocol set, or protocol stack, where the set (or stack) may comprise one or more protocols. For example, OSI and IP may each be considered to comprise a respective set of protocols, but may be referred to herein as OSI protocol or IP protocol respectively.

The present invention relates particularly, but not exclusively, to OSI and IP protocols, and respective ISO (International Organisation for Standardisation) and IETF (Internet Engineering Task Force) standards describing these protocols may be obtained respectively from www.iso.ch and www.ietf.org.

A network element supports one or more routing protocols in order to route data traffic across a network Integrated IS-IS (Intermediate System to Intermediate System) is a routing protocol that was devised as an extension to IS-IS muting protocol and, in conjunction with data tunnelling, allows network elements to route IP traffic as well as OSI traffic. Integrated IS-IS is described in IETF standard RFC 1195 which can be obtained from http://www.ietf.org/rfc/rfc1195.txt. IS-IS is described in ISO 10589 which can be obtained from http://www.iso.ch.

IS-IS and Integrated IS-IS normally employ a muting algorithm know as SPF (Shortest Path First) in order to calculate the “shortest” path across a network from one node to another. RFC 1195 and ISO 10589 are hereby incorporated herein by way of reference.

OSI traffic comprises OSI data packets, where OSI data packets conform with OSI protocol, particularly CLNP (ConnectionLess mode Network Protocol), CLNP being an OSI network layer protocol. CLNP is the name given to the type of data packets or PDUs (Protocol Data Units) that are used to provide CLNS (ConnectionLess mode Network Service), CLNS is the service provided by the network layer of an OSI protocol stack to higher layers of the stack. Provision of CLNS service results in CLNP packets or PDUs being passed to lower layers of the stack. IP traffic comprises IP data packets, where IP data packets conform with IP protocol, particularly IPv4 and IPv6 which are IP network layer protocols.

An IP-only network element, or node, is a node that can natively route IP packets but not OSI packets. An OSI-only node is a node that can natively route OSI packets, but not IP packets. A dual, or bi-lingual, network element, or network node, is a node that can natively route at least two protocols, particularly network layer protocols. This term is used hereinafter particularly to indicate either a node that routes both CLNS/CLNP and IPv4, or alternatively a node that routes both IPv4 and IPv6.

Hereinafter, the term “network node” (or “node”) is used in preference to “network element” to conform with the terminology favoured in International PCT patent application number PCT/EP01/14203, although either term may be used.

It will be understood that the term “router” as used hereinafter is intended to embrace a network element, or network node, (or part thereof) that is arranged to act as a data router. Hence, a “dual router” is a network node (or part thereof) that is capable of routing at least two protocol sets.

An adjacent network node (“adjacency”) is a reachable neighbouring node. The term “adjacency” is defined in section 3.6.3 of ISO/IEC 10589 and may be used herein to denote a reachable neighbouring node. A physical neighbouring node is not necessarily a valid adjacency, since it might be in a different network area or network level. Thus, an adjacency may be maintained between nodes that are not physical neighbours.

### SUMMARY OF THE INVENTION

A first aspect of the invention provides an apparatus for routing data packets in a network comprising a plurality of nodes each arranged to support one or both of a first and second set of one or more protocols, the apparatus being included, in use, in a first network node which is associated with at least one database, the apparatus being arranged to create entries in said at least one database, each entry relating to at least one respective path from said first network node to a respective destination node in the network, wherein the apparatus is arranged to determine, when creating an entry in respect of at least one path to a destination node, if said destination node supports both of said first and second protocol sets, and being further arranged, upon so determining, to associate information with said entry identifying said destination node as a dual router, and wherein the apparatus is further arranged, when creating subsequent entries in respect of paths to other destination nodes which paths include said destination node, to associate said identifying information with said subsequent entries.

The invention provides an efficient means of identifying the nearest dual routers in the paths to destination nodes. The apparatus need only test whether or not a given router, or node, is a dual router once, following which this information is carried in all subsequent database entries relating to a path that includes the identified dual router.

The invention is particularly suitable for use in a first network node which includes a first database for holding entries in respect of tentative paths to destination nodes, and a second database for holding entries in respect of shortest paths to destination nodes, the apparatus being arranged to derive at least some of the entries in said second database from respective entries in said first database, and to derive at least some of the entries in said second database from respective entries in said first database. This type of arrangement is exhibited in nodes that implement the SPF routing algorithm and so, in its particularly preferred form, the invention takes the form of a modified SPF algorithm.

Preferably, the dual router identifying information is included in each relevant database entry. More preferably, each database entry relating to at least one path to a destination node includes, in respect of the, or each path, a respective dual protocol field for carrying said identifying information, wherein the, or each, dual protocol field may be set to identify a dual router in the respective path, or to indicate that no known dual router exists in said respective path. Further preferably, when creating an entry in respect of at least one path to a destination node, the apparatus is arranged to determine if the destination node supports both of said first and second protocol sets only if at least one of the, or each, dual protocol field is set to indicate that no known dual router exists in the respective path. Upon determining that said destination node supports both of said first and second protocol sets, the apparatus is arranged to set the respective dual protocol field to identify said destination node.

In the preferred embodiment, the network nodes are arranged to implement one or more Link State Protocols and the apparatus is arranged to examine a respective routing data packet issued by a destination node in order to determine if said destination node supports one or both of said first and second protocol sets.

A second aspect of the invention provides a network node comprising an apparatus according to the first aspect of the invention.

A third aspect of the invention provides a heterogeneous network comprising one or more network nodes comprising an apparatus according to the first aspect of the invention.

A fourth aspect of the invention provides a method of identifying dual routers in an apparatus according to the first aspect of the invention.

A fifth aspect of the invention provides a computer program product comprising computer useable instructions for causing a computer to implement the method according to the fourth aspect of the invention.

Other advantageous aspects and features of the invention will be apparent to those ordinarily skilled in the art upon review of the following description of a specific embodiment of the invention and with reference to the accompanying drawings.

The preferred features as described herein above or as described by the dependent claims filed herewith may be combined as appropriate, and may be combined with any of the aspects of the invention as described herein above or by the independent claims filed herewith, as would be apparent to those skilled in the art.

### BRIEF DESCRIPTION OF THE DRAWINGS

An embodiment of the invention is now described by way of example and with reference to the accompanying drawings in which:

FIG. 1 is a schematic diagram of a heterogeneous network comprising a plurality of network nodes;

FIG. 2 is a schematic view of part of a network node, connected to the network of FIG. 1; and

FIGS. 3(a) to 3(l) show successive representations of a first database, TENT, and a second database, PATHS, as they are populated during a worked example of a preferred embodiment of the invention.

### DETAILED DESCRIPTION OF THE DRAWINGS

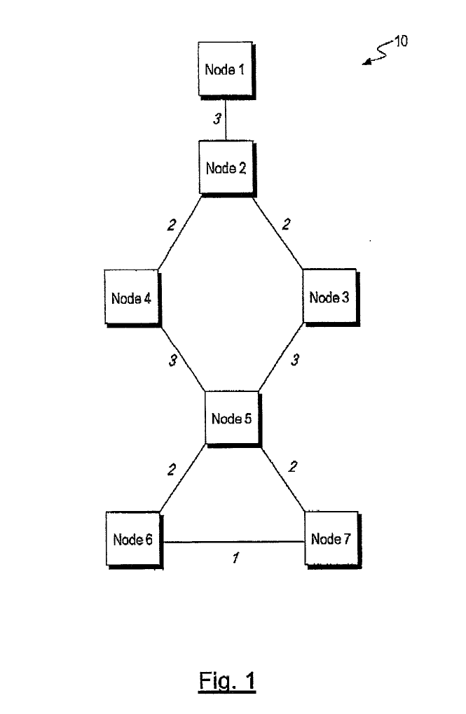

Referring firstly to FIG. 1, there is shown a network 10, or routing domain, comprising a plurality of network nodes, or network elements (numbered 1 to 7 in FIG. 1). The network nodes 1-7, which may also be referred to as systems (e.g. Intermediate System), are arranged to route data packets (not shown) across the network 10. Each network node may comprise one or more piece of network equipment, such as a multiplexer or a cross-connect, but also comprises routing apparatus to enable it to route data packets across the network 10. Since the present invention relates particularly to the routing of data packets, the nodes (1-7), and in particular the routing apparatus included in the nodes, may be referred to herein as routers. The routers may together form a level 1 IS-IS network area, or a level 2 subdomain, or may be separated into more than one level 1 network area. For illustrative purposes, the following description assumes that the network 10 is a level 1 network area. It will be noted that invention is concerned primarily with IS (Intermediate System) nodes and thus all of the nodes shown in network 10 are IS nodes.

The network 10 is also assumed to be heterogeneous in that each of the routers in the network 10 do not necessarily support a common protocol, particularly a network layer protocol such as CLNP (see ISO 8473-4), IPv4 (see RFC 791) or IPv6 (see RFC 2460).

The present example assumes that routers 2 and 3 are standard IS-IS or Integrated IS-IS routers running a first protocol, protocol A, where A may be any of, for example, CLNS/CLNP, IPv4, IPv6 or any other protocol that is routable using IS-IS or Integrated IS-IS.

It is further assumed that routers 6 and 7 are standard IS-IS or Integrated IS-IS routers running a second protocol, protocol B, where B may be a different protocol of CLNS/CLNP, IPv4, IPv6 or any other protocol that is routable using IS-IS or Integrated IS-IS.

Routers 1, 4 and 5 are assumed to be bi-lingual, or dual, routers that run Integrated IS-IS and can route both protocols A and B. Further, the dual routers 1, 4, 5 are arranged to run the SPF routing algorithm in order to determine the “shortest” path (typically “shortest” is measured in terms of cost, distance or other metric) across the network 10 to another node. The conventional SPF algorithm is defined in Annex C of RFC 1195.

In order to implement the auto-tunnelling scheme referred to above, each dual router 1, 4, 5 is required to determine, in respect of the respective shortest path to each other node in the network 10, the next, or nearest, node in the path that supports at least two protocols in common with itself. In the present example, the network 10 only supports two protocols, A and B, and so each dual router 1, 4, 5 needs to identify the next or nearest node in the path that is also a dual router. This allows the dual routers 1, 4, 5 to determine how data packets may be tunnelled across the network 10.

In accordance with a preferred embodiment of the invention, the routing algorithm, and in particular the SPF routing algorithm, is modified in order to compile the necessary information identifying the next dual router in the respective path to each other node in the network. More particularly, the SPF routing algorithm is modified to identify the next dual router in the respective path to each other IS node in the routing domain e.g. level 1 network area or level 2 sub-domain.

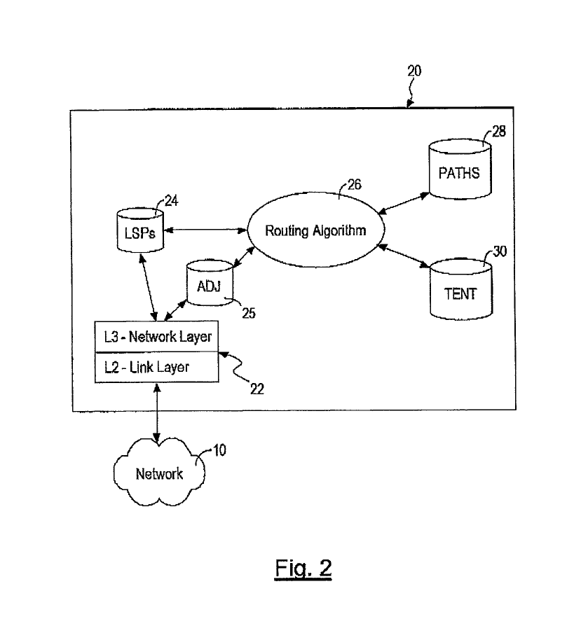

FIG. 2 shows a simplistic schematic view of a network element, or node 20, connected to network 10. For reasons of clarity, only those components of the node 20 that are necessary for understanding the invention are shown. The node 20 communicates with the network 10 via the Network Layer (L3) and Link Layer (L2) of a conventional protocol stack 22 (only L2 and L3 of the stack 22 are shown in FIG. 2). The stack 22 may be, for example, an OSI stack of an IP stack. A dual router normally includes two protocol stacks, one for each supported protocol, although this is not shown in FIG. 2 for reasons of clarity.

In accordance with IS-IS and Integrated IS-IS routing protocols, each router 1-7 in the network 10 creates routing data packets containing information about itself and causes these to be distributed to the other routers in the network 10. The routing data packets are normally referred to as Link State PDUs (LSPs), where PDU stands for Protocol Data Unit. Protocol Data Unit is an OSI term for data packet. Thus, LSP is sometimes used as an acronym for Link State Packet. The LSPs carry information about the node, or router, that issued them. This information includes identification of the, or each, other node in the network that is an adjacency to the issuing node, and an indication of cost, or metric. Integrated IS-IS LSPs also carry information identifying the, or each, protocol supported by the issuing node (this information is carried in a “protocols supported” field of the LSP). For example, in network 10, router 4 issues LSPs which identify routers 2 and 5 as its adjacencies and also indicates that router 4 supports both protocols A and B.

The node 20 gathers LSPs in respect of all other nodes in the routing domain (network 10) in conventional manner. The received LSPs are stored in a database, or other suitable memory structure, commonly known as an LSP database 24. The information stored in the LSP database 24 enables the node 20 to determine the topography of the network 10 of which it is part. This in turn allows the node 20 to calculate the shortest path to each other node in the network 10. To this end, the node 20 is arranged to run a routing algorithm 26 which, in the preferred embodiment, comprises the SPF algorithm. The node 20 further includes a conventional Adjacency database 25 for storing information identifying the, or each, adjacency of the node 20. This information is conveniently compiled in normal manner by inspecting routing data packets that are received by the node 20 from its neighbours.

In accordance with RFC 1195, the SPF algorithm performs its calculations in association with a first database 28, or other memory structure, known as PATHS and a second database 30, or other memory structure, known as TENT. PATHS can be considered as a directed graph of shortest paths, TENT holds the tentative placement of a system in PATHS. The LSP database 24, the PATHS database 23 and the TENT database 30 may be stored in one or more suitable conventional storage device (not shown).

In respect of each reachable node in the network 10, PATHS 28 contains an entry specifying: the destination address of the nude to which the entry relates; an indicator of the distance, cost, or metric, of sending a data packet to the node at the destination address along the shortest path as calculated by the SPF algorithm; and identification of the adjacency which serves as the beginning, or next hop, in said shortest path. The TENT database 30 includes one or more similar entries in respect of each reachable node in the network 10. However, entries in TENT 30 are not restricted to the shortest path. In simplistic view, the SPF algorithm calculates all possible paths to each destination node and places a corresponding entry in TENT 30 for each path. Then, the SPF algorithm determines which of these entries in TENT corresponds to the “shortest” path (normally by conducting a cost, or other metric, comparison). The entry for the shortest path to each destination node is then placed in PATHS 28. Within the operation of IS-IS and Integrated IS-IS routing protocols, the most CPU-intensive operation is normally the calculation of the SPF algorithm in order to populate the TENT 30 and PATHS 28 databases.

In order to implement the preferred embodiment of the present invention, the following modifications are made. An additional field, which may be referred to as the dual protocol field, is added to the PATHS 28 database for storing an identifier of the next, or nearest, dual router in the shortest path to the destination node. Conveniently, this may be achieved by modifying the structure (as defined in RFC 1195) of entries (also known as “triples” or elements) in PATHS 28 to include an additional field, so that the resulting entry takes the following form:

<N,d(N),{Adj(N)-DP(N)}>

Where N is a destination node identifier, the value of which specifies the destination address (typically in the form of a System ID (SID)), d(N) is a cost, or metric, indicator, the value of which specifies the distance or cost from the parent system, or node, SELF (i.e. the node performing the SPF calculations), and {Adj(N)-DP(N)} is a set of node identifier pairs, wherein the value of Adj(N) specifies the address, or System ID, of the adjacency that is the next hop on the shortest path to the node at N, and the value of DP(N) specifies the address, or System ID, of the next dual router on said shortest path. {Adj(N)-DP(N)} is shown as a set of address pairs since it is possible to have more than one shortest path to a destination node (where two paths share the same cost) and it is convenient that respective values of Adj(N) and DP(N) for each path are associated with one another. Thus {Adj(N)-DP(N)} may be said to be the set of valid adjacencies that the parent system SELF may use to forward a data packet to node N, together with a corresponding DP(N) entry representing the System ID of the first, or next, dual router on the path from SELF to node N. If the value of DP(N) is set to a null indicator, e.g. zero, or any other suitable indicator, this indicates that no known dual router exists on the path to the destination. The dual protocol field, DP(N), is emboldened in the above entry format to show how the entry format differs from the standard format described in RFC 1195. When the PATHS database 28 is completed by the SPF algorithm it contains a respective entry of the form described above for each reachable node, or system, in the routing domain.

Similarly, an additional dual router field is provided for entries in the TENT database 30. Conveniently, entries in TENT 30 take a form similar to that shown above for PATH entries except, in this case, the, or each, Adj(N)-DP(N) pair do not necessarily relate to the shortest path to the destination node N.

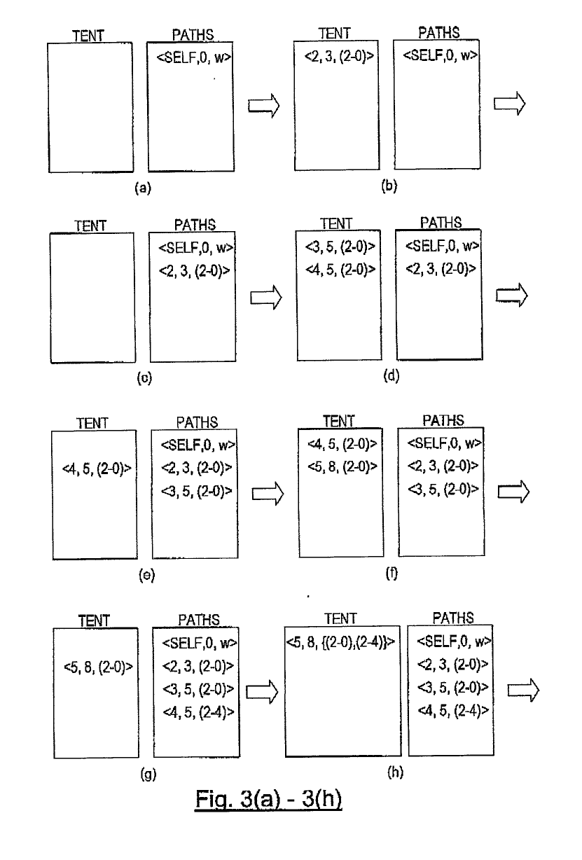

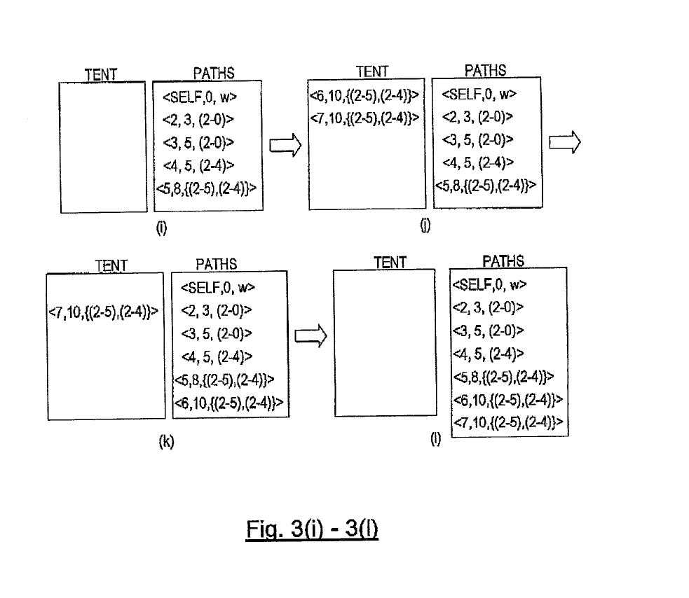

A description of the key aspects of the modified SPF algorithm according to the preferred embodiment of the invention is now described. The description is illustrated by way of example with reference to FIGS. 3(a) -(l) which show how the TENT and PATHS databases of node 1 (which is therefore the parent system SELF) are populated in the context of network 10. For the purposes of this example, the assumed relative costs (distance or metric) of each network section are annotated on FIG. 1 between adjacent nodes.

Upon initialisation, TENT 30 and PATHS 28 are empty. Firstly, a special case entry is added to PATHS 28 in respect of the node 20, or router, that is running the SPF algorithm. This node is commonly referred to as SELF and the special entry may conveniently take the form <SELF, 0, W-0>, where W indicates that traffic to SELF is passed up to internal processes (see FIG. 3(a)).

Then, a respective entry in TENT 30 is created for each adjacency of SELF. To achieve this, the SPF algorithm refers to the Adjacency database 25 and determines which routers are adjacencies to SELF and calculates the cost of sending a data packet to each adjacency. During this process, the value for DP(N) is set to null for each adjacent router, irrespective of whether or not it is in fact a dual router. In the example of network 10, an entry is placed in TENT in respect of node 2, node 2 being the only adjacency of parent node 1 (see FIG. 3(b) where N=2 (2 being the assumed System ID for node 2), d(N)=3 (from FIG. 1), Adj(N)=2 and D(N)=0).

Next, an entry in TENT 30 is moved into PATHS 28. In general, the entry that has the smallest cost/metric (d(N)) of the remaining entries in TENT 30 is moved to PATHS 28. Thus, at this stage, the TENT entry in respect of the adjacency to SELF with the lowest metric is moved to PATHS 28. If more than one entry in TENT shares the same d(N), then any suitable rule may be applied to select one of them. For example, an entry relating to a psuedonode may be selected or it may simply be decided to chose the entry relating to the node with the lowest System ID. When an entry is moved from TENT to PATHS, it is deleted from TENT. In the worked example, there is only one entry in TENT and so this is moved to PATHS and deleted from TENT (FIG. 3(c)).

When an entry is moved from TENT to PATHS, unlike conventional SPF, the modified SPF algorithm is arranged to check whether or not the node N to which the new entry in PATHS relates is a dual router. To achieve this, the modified routing algorithm 26 refers to the LSP database 24 and examines the LSP issued by the node N to determine which protocols are supported. Conveniently, this is achieved by examining the “protocols supported” field of an Integrated IS-IS LSP. If the node N is not a dual router, then the DP(N) value is left at the null indicator (zero in this example). If the node N is a dual router, then the value of DP(N) is set to the system ID of the node N. Thus, the value of DP(N) now provides identification of the next dual router in the shortest path to node N (which at his stage would be the node N itself). Because, in the preferred embodiment, the modified routing algorithm 26 need only identify the first, or nearest, dual router in the path, the routing algorithm 26 need only check whether or not node N is a dual router if the value of DP(N) is the null indicator. Thus, if an entry in TENT is selected for placement in PATHS and its value of DP(N) is not null, then this value is kept as the value for DP(N) in the new PATHS entry. It is noted that in some conventional notation, the character N is replaced with the character P to distinguish an entry in PATHS as opposed to TENT. This notation is adopted hereinafter for reasons of clarity. Hence the new entry in PATHS may be written:

<P,d(P),{Adj(P)-DP(P)}>

If the node P in respect of which an entry has just been moved from TENT to PATHS is an Intermediate System, then the routing algorithm 26 refers to the LSP database 24 and examines the LSP of the node P, in conventional manner, to identify its adjacencies with a view to creating one or more new entries in TENT in respect of the, or each, adjacency of node P. Also from the relevant LSP information, the routing algorithm 26 calculates the cumulative cost/metric in sending a data packet from the parent node SELF (node 1 in the present example) to each of the identified adjacencies of node P via node P. A number of conditions must be satisfied before a new entry in TENT is created. The relevant of these conditions are now outlined. In respect of the, or each, adjacent node to node P, the routing algorithm 26 checks if PATHS already contains an entry in respect of the respective adjacent node. If so, then no new entry is created in TENT in respect of that adjacent node. The routing algorithm 26 also checks if TENT already contains an entry in respect of the, or each, respective adjacent node. If not, then a new entry is created in TENT in respect of that adjacent node. If TENT does already contain an entry in respect of a given adjacency to node P, then the routing algorithm 26 performs a cost or metric comparison between the existing entry in TENT in respect of the given adjacency and the cost metric that it has just calculated for the given adjacency. If the former cost is less than the latter cost, then the routing algorithm 26 does not create a new entry in TENT in respect of the given adjacency. If the former cost is greater than the latter cost, then the muting algorithm deletes the existing entry in TENT in respect of the given adjacency and creates a new entry in TENT using the cost information that has just been calculated. If the former cost is equal to the latter cost, then the routing algorithm 26 creates a new entry in TENT (or amends the existing entry) that incorporates both the information contained in the existing entry and the newly calculated information in respect of the give adjacency. In this case, the N and d(N) components of the entry in TENT will remain unchanged but an additional Adj(N)-DP(N) pair will be added to the set {Adj(N)-DP(N)}. The newly added Adj(N)-DP(N) pair may have the same value for Adj(N) as the existing entry in TENT for the given adjacency but a different value for DP(N), or vice versa.

Each new entry in TENT takes the form illustrated above, wherein the value of N is now equal to the System ID of the respective adjacent node in respect of which the new TENT entry is being made, d(N) is the cumulative cost from the parent node SELF to the respective adjacent node and the respective values of Adj(N) and DP(N) are the same as the corresponding values in the entry in PATHS from which the new TENT entry was derived i.e. Adj(P) and DP(P) respectively. As a result, since the value of DP(P) identifies, where applicable, the existence of a dual router in a path to node P (in some gases P itself will be the dual router) then, once a dual router is identified by the modified routing algorithm 26 in the manner described above, all subsequent entries in TENT (and further subsequent new entries in PATHS) which relate to network paths that include the identified dual router will be marked as such. Transferring, or carrying, the system IDs of dual routers from PATH entries to new TENT entries in this way is an efficient way to identify dual routers in network paths and is found to significantly reduce the computational burden on the routing algorithm that would otherwise be incurred.

In the worked example, FIG. 3(d) shows that two new entries have been made in TENT as a result of the operations described above: a respective entry has been made for routers 3 and 4, these routers being adjacencies of router 2.

The next step for the algorithm 26 is to refer to TENT again in order to identify the next entry to be moved to PATHS. As described above, the routing algorithm 26 selects the entry in TENT which has the lowest metric d(N). In the worked example, FIG. 3(d) shows two entries in TENT, each having the same cost d(N). In this example, the algorithm 26 is arranged to select the entry relating to the router with the lowest system ID, which in this case is the entry for router 3. So the TENT entry for router 3 is deleted and a corresponding new entry is placed in PATHS, where the new values for P, d(P), Adj(P) and DP(P) are carried over from the router 3 TENT entry. The modified routing algorithm 26 then checks whether or not router 3 is a dual router in the manner described above. In this example, router 3 is not a dual router and so the value of DP(P) remains as zero. The resultant states of the TENT and PATHS databases are shown in FIG. 3(e).

The routing algorithm 26 then determines the adjacencies of router 3 (which is an IS node) which, as can be seen from FIG. 1 are routers 2 and 5. PATHS already contains an entry in respect of router 2 and so the routing algorithm 26 does not create a new entry in TENT in respect of FIG. 2. There is no entry in either TENT or PATHS for router 5 and so the routing algorithm 26 creates a new entry in TENT for router 5. The values for Adj(5) and DP(5) are carried over from the entry in PATHS for router 3 i.e. Adj(5)=2, DP(5)=0. From FIG. 1 it can be seen that the cumulative metric from SELF (router 1) to router 5 via router 3 is: d(5)=3+2+3=8. The resultant state of TENT and PATHS is shown in FIG. 3(f).

Next, the routing algorithm 26 again removes the TENT entry with lowest metric and adds a corresponding entry to PATHS. This time, the TENT entry for router 4 is removed from TENT and a corresponding new entry for router 4 is added to PATHS. Since the value of DP(N) for router 4 is zero in TENT, the modified routing algorithm 26 checks whether or not router 4 is a dual router. In this example, router 4 is a dual router and so the routing algorithm 26 sets the value of DP(P) in the new router 4 PATHS entry to the system ID of router 4. The resultant state of TENT and PATHS is shown in FIG. 3(g).

Next, the routing algorithm 26 determines the adjacencies of router 4, which are routers 2 and 5 (FIG. 1). PATHS already contains an entry for router 2 and so no new entry for router 2 is created for TENT. TENT already contains an entry for router 5 and so the routing algorithm 26 makes a metric comparison between the existing TENT entry for router 5 and the metric that it has just calculated in respect of router 5. In the present example, the cost or metric to router 5 is the same (d(N)=8). Thus, the routing algorithm 26 creates a new entry in TENT (or amends the existing one) for router 5 which incorporates information relating to both paths to router 5. Conveniently this is achieved by adding another {Adj(N)-DP(N)} pair to the TENT entry for router 5. Thus, the new TENT entry for router 5 is as follows: <5, 8, {(2-0), (2-4)}>, the values for the second Adj(N)-DP(N) pair (2-4) are carried over from the PATHS entry for router 4 (see FIG. 3(h)).

Next, the routing algorithm 26 creates a new entry in PATHS for router 5 since the only entry in TENT is the router 5 entry. The router 5 entry in TENT contains a Adj(N)-DP(N) pair (2-0) in which the value of DP(N) is null. Thus, the modified routing algorithm 26 checks whether or not router 5 is a dual router. Finding that router 5 is a dual router, the modified routing algorithm 26 sets the value of DP(P) to the system ID of router 5 for that particular Adj(N)-DP(N) pair. The router 5 entry in TENT is removed form TENT. The resultant state of TENT and PATHS is shown in FIG. 3(i).

Next, the routing algorithm 26 determines the adjacencies of router 5, which are routers 3, 4, 6 and 7. PATHS already contains respective entries for routers 3 and 4 and so no new entries in TENT are made in rest of these routers. However, a respective new entry in TENT is made for routers 6 and 7. The respective values for d(N) are the cumulative metric to the respective routers 6, 7 as calculated by the routing algorithm 26. The values of Adj(P) and DP(P) from the router 5 entry in PATHS are carried over to the new entries in TENT as Adj(N) and DP(N). The resultant state of TENT and PATHS is shown in FIG. 3(j).

Next, the routing algorithm 26 compares the two entries in TENT to determine which should be moved to PATHS. This time the respective metrics are the same (10) and so the entry with the lowest System ID is selected, namely the entry for router 6. Thus, the routing algorithm creates a new entry in PATHS for router 6. There are no null values for DP(N) in the router 6 TENT entry and so the routing algorithm 26 does not need to check whether or not router 6 is a dual router. Hence, the values for P, d(P), Adj(P) and DP(P) in the new router 6 PATHS entry are exactly the same as the router 6 TENT entry. The router 6 TENT entry is deleted from TENT. The resulting state of PATHS and TENT is shown in FIG. 3(k).

The routing algorithm 26 then determines the adjacencies of router 6, namely routers 5 and 7. PATHS already has an entry for router 5 and so no new entry for router 5 is created in TENT. TENT already has an entry for router 7 and so the routing algorithm 26 compares the metric d(N) of the existing router 7 TENT entry with the metric or cost that it has just calculated for router 7. In this case, the routing algorithm 26 finds that the cost associated with the existing router 7 entry in TENT is lower than the cost calculated for reaching router 7 via router 6 (3+2+3+2=10 compared with 3+2+3+2+1=11) and so no new entry is created in TENT. The state of TENT and PATHS therefore remains unchanged from FIG. 3(k).

Next, the routing algorithm 26 refers again to TENT to select a new entry for PATHS. Finding only one entry in TENT, namely the entry for router 7, the routing algorithm 26 creates a new entry in PATHS for FIG. 7 and deletes the router 7 entry from TENT. Since none of the values of DP(N) are null, the routing algorithm 26 does not need to check whether or not router 7 is a dual router. Hence, the values for P, d(P), Adj(P) and DP(P) in the new router 7 PATHS entry are exactly the same as the deleted router 7 TENT entry. The resulting state of PATHS and TENT is shown in FIG. 3(l).

The routing algorithm 26 then determines the adjacencies of router 7, finding routers 5 and 6. PATHS already contains respective entries for these two routers and so no further entries in TENT are made. When the routing algorithm 26 refers again to TENT to determine what entry should next be made in PATHS, it finds that TENT is empty. This signals that the routing algorithm 26 has finished calculating paths across the network. Thus, the final state of TENT and PATHS is as shown in FIG. 3(l).

It will be appreciated from the foregoing that the modified algorithm 26 according to the preferred embodiment of the invention provides an efficient means of identifying the nearest dual routers in the shortest paths to destination nodes. The routing algorithm 26 need only test whether or not a given router, or node, is a dual router once, following which this information is carried between the TENT and PATHS databases in all subsequent entries relating to a path that includes the identified dual router. Thus, when the routing algorithm 26 completes the PATHS database, information identifying the nearest dual router in each shortest path is already included in each relevant entry. This is achieved with a significantly reduced computational burden in comparison with, for example, revisiting each shortest path after completion and examining the nodes in each path to identify dual routers.

It is not essential that respective values for Adj(N), Adj(P) and DP(N), DP(P) are stored in respective pairs. The respective values for these parameters may equally be stored in separate fields. It is convenient to store them in pairs as described above especially when the set of {Adj(N)-DP(N)} or {Adj(P)-DP(P)} comprise more than one member (see FIGS. 3(h) to 3(l) by way of example).

It will be understood that, as is conventional, each router in the network 10 performs a routing algorithm, in this case SPF routing algorithm, in order to create and maintain its own PATHS database. However, only the dual routers are required to implement the modified routing algorithm of the invention.

Further, in the preferred embodiment wherein all of the bi-lingual routers implement Integrated IS-IS, it is not essential that all of the single language routers also run Integrated IS-IS. For example, the OSI-only routers may run IS-IS only. This normally means that their LSPs will not include a “protocols supported” field, but the routing algorithm may be modified to recognise that the absence of a “protocols supported” field in an LSP signifies that the router that issued the LSP is OSI-only.

End Systems do not affect the operation of the present invention and may be treated in normal manner by the routing algorithm.

The invention is described above with particular reference to the PATHS, TENT, Adjacency and LSP databases. A skilled person will appreciate that these database do not necessarily need to be implemented separately and that the information carried therein may alternatively be stored in one or more database, or other suitable memory structure. Further, it is not essential that the, or each, database be included in the parent node. For example, in an alternative embodiment, the or each database may be held in a server (not shown), or other computer system, that interfaces with the parent node, or may be stored in an external storage device (not shown).

It will be understood that the present invention is not limited to use with Integrated IS-IS and may be used with systems running other Link State protocols. Other Link State Protocols, such as Open Shortest Path First (OSPF), also use Link State PDUs (known as Link Sate Advertisements LSAs) in the case of OSPF) to enable communication amongst routers. In some cases, the LSPs/LSAs do not include a “protocol supported” field. The invention is therefore particularly suited for use with Link State protocols wherein the LSPs, or equivalent data packet, do include a “protocols supported” field or wherein it is possible to modify the LSP, or equivalent data packet, to include a field for carrying this information. By way of example, the invention may be used to tunnel IPv6 over IPv4 (or vice versa) using OSPF.

There follows a specific example of a modified routing algorithm illustrating how the preferred embodiment of the invention may be implemented. The modified routing algorithm is based on the SPF algorithm commonly known as Dijkstra's algorithm which is described in RFC 1195. The modifications made in accordance with the invention are shown in bold, italic typescript.

Step 0: Initialize TENT and PATHS to empty. Initialize tentlength to [internalmetric=0, externalmetric=0].

(tentlength is the pathlength of elements in TENT that we are examining.)

1) Add <SELF,0,W-0>to PATHS, where W is a special value indicating traffic to SELF is passed up to internal processes (rather than forwarded).

2) Now pre-load TENT with the local adjacency database (Each entry made to TENT must be marked as being either an End System or a router to enable the check at the end of Step 2 to be made correctly—Note that each local IP reachability entry is included as an adjacency, and is marked as being an End System). For each adjacency Adj(N) including level 1 OSI Manual Adjacencies, or level 2 OSI enabled reachable addresses, and IP reachability entries) on enabled circuits, to system N of SELF in state “Up” compute.

d(N)=cost of the parent circuit of the adjacency (N), obtained from metric.k, where k=one of {default metric, delay metric, monetary metric, error metric}

Adj(N)-DP(N)=the adjacency number of the adjacency to N and the SID of the next-hop dual router along the path to the neighbour which in this case i.e. during initialisation will be set to 0

3) if a triple <N,x,{Adj(M)-DP(N)}>is in TENT, then:

If x=d(N), then {Adj(M)-DP(N)}←{Adj(M)-DP(M)}U{Adj(N)-DP(N)}.

4) If N is a router or an OSI End System entry, and there are now more adjacencies in {Adj(M)} than maximumPathSplits, then remove excess adjacencies as described in Clause 7.2.7 of [1]. If N is an IP Reachability Entry, then excess adjacencies may be removed as desired. This will not affect the correctness of routing, but may eliminate the determinism for IP routes (i.e., IP packets still follow optimal routes within an area, but where multiple equally good routes exist, will not necessarily follow precisely the route that any one particular router would have anticipated).

5) If x<d(N), do nothing.

6) If x>d(N), remove <N,x,{Adj(M)-DP(M)} from TENT and add the triple <N,d(N),{Adj(N)-DP(N)}>

7) If no triple <N,x,{Adj(M)-DP(M)}>is in TENT, then add <N,d(N),{Adj(N)-DP(N)}>to TENT.

8) Now add systems to which the local router does not have adjacencies, but which are mentioned in neighboring pseudonode LSPs. The adjacency for such systems is set to that of the designated router. Note that this does not include IP reachability entries from neighboring pseudonode LSPs. In particular, the pseudonode LSPs do not include IP reachability entries.

9) For all broadcast circuits in state “On”, find the pseudonode LSP for that circuit (specifically, the LSP with number zero and with the first 7 octets of LSPID equal to LnCircuitID for that circuit, where n is 1 (for level 1 routing) or 2 (level 2 routing)). If it is present, for all the neighbors N reported in all the LSPs of this pseudonode which do not exist in TENT add an entry <N,d(N),{Adj(N)-DP(N))>to TENT, where:

d(N)=metric.k of the circuit.

Adj(N)=the adjacency number of the adjacency to the DR.

10) Go to Step 2.

Step 1: Examine the zeroeth link state PDU of P, the system just placed on PATHS (i.e., the ISP with the same first 7 octets of LSPID as P, and LSP number zero).

1) If this LSP is present and the “Infinite Hippity Cost” bit is clear For each Adj(*)-DP(*) pair in the PATHS database for P. If this is not a pseudo-node LSP and if DP(*) is equal to zero then check the protocols supported field of the LSP, if it contains both IP and CLNS then set the DP(P)value for this adjacency to be the system ID of P.

2) If this LSP is present, and the “Infinite Hippity Cost” bit is clear, then for each LSP of P (i.e., all LSPs with the same first 7 octets of LSPID and P, irrespective of the value of LSP number) compute:

dist(P,N)=d(P)+metric.k(P,N)

for each neighbor N (both End system and router) of the system P. If the “Infinite Hippity Cost” bit is set, only consider the End System neighbors of the system P.

Note that the End Systems neighbors of the system P includes IP reachable address entries included in the LSPs from system P. Here, d(P) is the second element of the triple

<P,d(P),{Adj(P)-DP(P)}>

and metric.k(P,N) is the cost of the link from P to N as reported in P's link state PDU.

3) If Neighbour N is of a network protocol type not supported by P and DP(P) is equal to zero then P must be a split stack node and DP(N) should be set to the SID of P

4) If dist(P,N)>MaxPathMetric then do nothing.

5) if <N,d(N),{Adj(N)-DP(N)}>is in PATHS, then do nothing.

Note: d(N) must be less than dist(P,N), or else N would not have been put into PATHS. An additional sanity check may be done here to ensure that d(N) is in fact less than dist(P,N)

6) If a triple <N,x,{Adj(N)-DP(N)}>is in TENT, then:

a) If x=dist(P,N), then

{Adj(N), DP(N)}<-{Adj(N)-DP(N)}U{Adj(P)-DP(P)}.

Note that even if the value of Adj(N) is equal to the value Adj(P) but the corresponding values of DP(P) and DP(N) are different then this should be treated as a different adjacency and will represent a different path to the destination.

b) If N is a router or an OSI end system, and there are now more adjacencies in {Adj(N)} than maximumPath Splits, then remove excess adjacencies, as described in clause 7.2.7 of [1]. For IP Reachability Entries, excess adjacencies may be removed as desired. This will not effect the correctness of routing, but may eliminate the determinism for IP routes (i.e., IP packets will still follow optimal routes within an area, but where multiple equally good routes exist, will not necessarily follow precisely the route that any one particular router would have anticipated).

c) if x<dist(P,N), do nothing.

d) if x>dist(P,N), remove <N,x,{Adj(N)-DP(N)}>from TENT, and add <N,dist(P,N),{Adj(P)-DP(P)}>

7) if no triple <N,x,{Adj(N)}>is in TENT, then add <N,dist(P,N),{Adj(P)}>to TENT,

Step 2: If TENT is empty, stop. Else:

1) Find the element <P,x,{Adj(P)-DP(P)}>, with minimal x as follows:

a) If an element <*,tentlength,*>remains in TENT in the list for tentlength, choose that element. If there are more than one elements in the list for tentlength, choose one of the elements (if any) for a system which is a pseudonode in preference to one for a non-pseudonode. If there are no more elements in the list for tentlength, increment tentlength and repeat Step 2.

b) Remove <P,tentlength,{Adj(P)-DP(P)}>from TENT.

c) Add <P,d(P),Adj(P)-DP(P)}>to PATHS.

d) If this is the Level 2 Decision Process running, and the system just added to PATHS listed itself as Partition Designated Level 2 Intermediate system, then additionally add <AREA,P,d(P),{Adj(P)}>to PATHS, where AREA.P is the Network Entity Title of the other end of the Virtual Link, obtained by taking the first AREA listed in P's LSP and appending P's ID.

e) If the system just added to PATHS was an end system, go to step 2, Else go to Step 1.

NOTE—In the level 2 context, the “End Systems” are the set of Reachable Address Prefixes (for OSI), the set of Area Addresses with zero cost (again, for OSI), plus the set of IP reachability entries (including both internal and external).

It will be seen from Step 1, 3) that the modified SPF algorithm may be used in networks where one or more of the nodes are split stack nodes. If a neighbouring node N, or adjacency, supports a protocol set not supported by node P and if the value of DP(P) is equal to zero (i.e. P is not a dual router) then P is assumed to be a split stack node and DP(N) should be set to the SID of node P.

The above description refers to an algorithm in which it is assumed that a dual router is capable of encapsulating and de-encapsulating packets of both supported protocols, A and B. If the algorithm is to be used in a network containing one or more dual routers which are not capable of encapsulating and de-encapsulating packets of both supported protocols then certain changes can be made to the algorithm, By assigning a suitable identifier indicating support for the encapsulation/de-encapsulation function, it is possible to identify not only whether a dual router is able to support one or more protocols, but also to identify explicitly its ability to encapsulate/de-encapsulate the protocols it supports.

One embodiment of the invention which enables this, for example, requires firstly the entries in both the PATHS and TENT to be updated to contain instead of one DP(N) entry, two entries one for each protocol. For example, an entry to a destination N could have the following format:—

<N,d(N),{Adj(N)-ADP(N)-BDP(N)}

Where:

ADP(N)—Is the next router along the PATH to N capable of encapsulating and de-encapsulating packets of protocol A in packets of protocol B.

BDP(N)—Is the next router along the PATH to N capable of encapsulating and de-encapsulating packets of protocol B in packets of protocol A.

Secondly, when moving an entry from the TENT database to the PATHS database instead of examining the “protocols supported” field of an LSP, one or more fields may be examined which indicate the encapsulation capability, for example—the “Encapsulation Capability field(s)” (a name which may change) could be examined for each protocol. If the value of this field in the LSP indicates that this router is capable of encapsulating and de-encapsulating protocol A over protocol B packets and the value of ADP(N) is set to the NULL indicator then the value of ADP(N) should be set to the SID of this router. If the value of this field in the LSP indicates that this router is capable of encapsulating and de-encapsulating protocol B over protocol A packets and the value of BDP(N) is set to the NULL indicator then the value of BDP(N) should be set to the SID of this router. All other behaviour of the algorithm should remain as described hereinabove with reference to other embodiments of the invention.

In the above embodiment, the algorithm utilises a new type-line value (TLV) which enables both an IP over OSI dual router and a OSI over IP dual router to be located instead of simply looking for dual routers per se. Instead of an “adjacency-dual protocol router” pair associated with each entry in the PATHS table, an “adjacency-OSIoverIP dual protocol router-IPoverOSI dual protocol router” entry is associated, (Note, that in most cases the OSIoverIP and IPoverOSI DP routers will be the same.)

As an example, in one embodiment of the invention the TLV (or equivalently code-line value) could comprise the following:

Code=16(decimal) (meaning “encapsulation/deencapsulation capability” field);

Length=length of value field

Value:

1st byte=1

This byte is for future versions or options or uses, but can be set to 1 for this initial version.

Bytes 2,3,4 are a triplet of the form:

encapsulation_mode=47 for GRE (Generic Routing Encapsulation) as per RFC 1701,1702,2784,3147)

inner_protocol=the NLPID of the protocol that can be received in encapsulation form

outer_protocol=the NLPID of the protocol that can be used to transport the encapsulated packet

A second, third, fourth and so on triplet can then be added as necessary

The TLV can be expanded for other uses in the future by two mechanisms. Firstly, by using a number different to 47, in which case the triplet need not even be a triplet anymore. For example, if a sub-feature that needs 5 bytes is defined it can be given a number of 35, for example. It is also envisaged that IP over IP could use the IP protocol number for IP over IP encapsulation (4) for example, Secondly, by using a new first byte, other than 1, in which case all previous definitions are invalid and we can start again, without needing a new TLV number.

In such an example, in a typical dual NE the TLV could be included in LSPs (level-1 and level-2) and could comprise:—

16: the code

7: the value length (in this example)

1: initial version/option

47: next two bytes are a supported GRE mode

129: IPI for CLNP from ISO 9577 as inner

204: IPI for IPv4 from ISO 9577 as outer

47: next two bytes are a supported GRE mode

204: IPI for IPv4 from ISO 9577 as inner

129: IPI for CLNP from ISO 9577 as outer

In this case the TLV indicates that the IS can receive CLNPoverIP (RFC 1702) in the first triplet and IPoverCLNS (RFC 3147) in the second.

As an example, it is possible for an IP interface to not be configured on a card and yet the card advertises itself as a dual router. In this instance, if an explicit encapsulation capability field is not used, an error event may occur as an IP address cannot be determined for the card and therefore packets cannot be encapsulated in IP and sent to the card.

Advantageously, it is possible to prevent such situations occurring using the invention in at least two ways. For example, using the above embodiment the PATHS triplets can be modified to store two systems IDs. The first ID in this embodiment is able to do IPoverCLNS termination, and is used in the IP forwarding table, effectively indicating “encapsulate and send here”. The second ID indicates the capability to do CLNPoverIP, and this ID is put into the OSI forwarding table, effectively indicating “encapsulate and send here”. Although the two system IDs should normally be the same they need not always be. Alternatively, one can simply use the algorithm which determines routers able to support both protocols and constrain the search for the next dual router such that the next dual router must have a TLV with both triplets in it (e.g. IPoverCLNS and CLNPoverIP). For clarity, as is known to those skilled in the art, the equivalent also applies to OSIoverIP and IPoverOSI embodiments of the invention.

It is useful if the encapsulation capability can be determined when computing routes. For example, if no indication is provided of encapsulation capability, then dual routers which do not in fact have encapsulation capability despite being able to support both protocols could be erroneously selected as termination points for autotunnelling. In particular, the order of encapsulation can be indicated by the encapsulation capability identifier, i.e., whether OSI over IP is supported but not IP over OSI.

The invention is not limited to the embodiments described herein which may be modified or varied without departing from the scope of the invention.

The text of the abstract repeated herein below is hereby deemed incorporated into the description:

In the preferred embodiment, the invention provides a modified Shortest Path First routing algorithm for use in a heterogeneous network. The routing algorithm is modified to identity bi-lingual network nodes as it calculates shortest paths. Once a node has been identified as bi-lingual, this information is carried over into subsequent path entries created by the routing algorithm. This arrangement reduces the computational burden on the routing algorithm when identifying bi-lingual routers. The algorithm may be modified to enable the use of an encapsulation capability identifier to indicate the encapsulation capability of bi-lingual routers, and the algorithm may be modified to use the encapsulation capability identifier in the calculation of the shortest paths.

1. An apparatus for routing data packets in a network comprising a plurality of nodes each arranged to support one or both of a first and second set of one or more protocols, the apparatus being included, in use, in a first network node which is associated with at least one database, the apparatus being arranged to create entries in said at least one database, each entry relating to at least one respective path from said first network node to a respective destination node in the network, wherein the apparatus is arranged to determine, when creating an entry in respect of at least one path to a destination node, if said destination node supports both of said first and second protocol sets, and being further arranged, upon so determining, to associate information with said entry identifying said destination node as a dual router, and wherein the apparatus is further arranged, when creating subsequent entries in respect of paths to other destination nodes which paths include said destination node, to associate said identifying information with said subsequent entries.

2. An apparatus as claimed in claim 1, wherein the apparatus is arranged to determine, when creating an entry in respect of at least one path to a destination node, the encapsulation capability of said destination node which supports both of said first and second protocol set.

3. An apparatus as claimed in claim 1, said first network node including a first database for holding entries in respect of tentative paths to destination nodes, and a second database for holding entries in respect of shortest paths to destination nodes, the apparatus being arranged to derive at least some of the entries in said second database from respective entries in said first database, and to derive at least some of the entries in said second database from respective entries in said first database.

4. An apparatus as claimed in claim 3, wherein the apparatus is arranged to determine if a destination node supports both of said first and second protocols when creating an entry in said second database, and to associate said identifying information with the, or each, entry in the first database which is subsequently derived from said entry in the second database.

5. An apparatus as claimed in claim 3, wherein said apparatus is arranged to determine the encapsulation capability of said destination node in respect of said first and second protocol sets when creating an entry in said second database, and to associate said identifying information which the, or each, entry in the first database, and to associate said identifying information with the, or each, entry in the first database which is subsequently derived from said entry in the second database.

6. An apparatus as claimed in claim 4, wherein the apparatus is arranged to associate said identifying information with one or more subsequent entries in said second database derived from the, or each, of said first database entries.

7. An apparatus as claimed in claim 3, wherein, in respect of an entry added to said second database, the apparatus is arranged to create selectively a respective entry in said first database in respect of at least one path to the, or each, network node that is adjacent the destination node to which said added second database entry relates.

8. An apparatus as claimed in claim 3, wherein each entry includes an indicator of the cost of sending a data packet from the first node to the destination node of the entry, the apparatus being arranged to create an entry in said second database in respect of the entry in the first database having the lowest cost indicator.

9. An apparatus as claimed in claim 1, wherein the apparatus is arranged to include said identifying information in each relevant database entry.

10. An apparatus as claimed in claim 9, in which each database entry relating to at least one path to a destination node includes, in respect of the, or each path, a respective dual protocol field for carrying said identifying information, wherein the, or each, dual protocol field may be set to identify a dual router in the respective path, or to indicate that no known dual router exists in said respective path.

11. An apparatus as claimed in claim 10, wherein, when creating an entry in respect of at least one path to a destination node, the apparatus is arranged to determine if the destination node supports both of said first and second protocol sets only if at least one of the, or each, dual protocol field is set to indicate that no known dual router exists in the respective path.

12. An apparatus as claimed in claim 11, whereupon determining that said destination node supports both of said first and second protocol sets, the apparatus is arranged to set the respective dual protocol field to identify said destination node.

13. An apparatus as claimed in claim 10, wherein each of said entries further includes at least one adjacent node field for identifying which adjacent node of said first node is the first node in said path to the destination node, and wherein the, or each, adjacent node field is associated with a respective dual protocol field.

14. An apparatus as claimed in claim 1, wherein the network nodes are arranged to implement one or more Link State Protocols and wherein said first network node includes a third database for storing routing data packets that are distributed by each other network node in accordance with the, or each, Link State Protocol, the apparatus being arranged to examine the respective routing data packet issued by a destination node in order to determine if said destination node supports one or both of said first and second protocol sets.

15. An apparatus as claimed in claim 14, wherein at least the network nodes that support both of said first and second protocol sets are arranged to support Integrated IS-IS Link State Protocol, the apparatus being arranged to examine the “protocols supported” field of the respective routing data packets.

16. An apparatus as claimed in claim 14, wherein at least the network nodes that support both of said first and second protocol sets are arranged to support Integrated IS-IS Link State Protocol, the apparatus being arranged to examine the “encapsulation capability” field of the respective routing data packets.

17. An apparatus as claimed in claim 1, wherein said first and second protocol sets each comprise an OSI protocol set or an IP protocol set.

18. A network node comprising an apparatus as claimed in claim 1.

19. A heterogeneous network comprising one or more network nodes comprising an apparatus as claimed in claim 1.

20. In an apparatus for routing data packets in a network comprising a plurality of nodes each arranged to support one or both of a first and second set of one or more protocols, the apparatus being included, in use, in a first network node which includes at least one database, the apparatus being arranged to create entries in said at least one database, each entry relating to at least one respective path from said first network node to a respective destination node in the network, a method of identifying dual routers, the method comprising: determining, when creating an entry in respect of at least one path to a destination node, if said destination node supports both of said first and second protocol sets;
associating, upon so determining, information with said entry identifying said destination node as a dual router; and, when creating subsequent entries in respect of paths to other destination nodes which paths include said destination node, associating said identifying information with said subsequent entries.

21. A computer program product comprising computer useable instructions for causing a computer to implement the method claimed in claim 20.

22. In an apparatus for routing data packets in a network comprising a plurality of nodes each arranged to support one or both of a first and second set of one or more protocols, the apparatus being included, in use, in a first network node which includes at least one database, the apparatus being arranged to create entries in said at least one database, each entry relating to at least one respective path from said first network node to a respective destination node in the network, a method of identifying dual routers, the method comprising: determining, when creating an entry in respect of at least one path to a destination node, the encapsulation capability of said destination node if said destination node supports both of said first and second protocol sets associating, upon so determining, information with said entry identifying said destination node as a dual router having said encapsulation capability, and, when creating subsequent entries in respect of paths to other destination nodes which paths include said destination node, associating said identifying information with said subsequent entries.
